(19) United States
(12) Patent Application Publication
(10) Pub. No.: US 2012/0230762 A1
(43) Pub. Date: Sep. 13, 2012

(54) AUXILIARY ACTUATION DEVICE, HOUSING AND ROTARY LOCKING DEVICE FOR A MOTOR VEHICLE

(76) Inventor: Eduard Ruff, Auerbach (DE)

(21) Appl. No.: 13/502,398

(22) PCT Filed: Sep. 22, 2010
(86) PCT No.: PCT/EP2010/063951

§ 371 Date: Apr. 17, 2012

(30) Foreign Application Priority Data
Oct. 20, 2009 (DE) 10 2009 045 827.1

(51) Int. Cl. F16B 5/10

(52) U.S. Cl. 403/349

(57) ABSTRACT

A supplementary actuation device (1) inserted in a housing (2) is provided for the positioning of a bolt component (9) which is rotationally locked in position to the housing (2), wherein a signal is reliably delivered in the case of a resulting rotational locking of the housing (2) with the bolt component (9) by means of rotating the supplementary actuation device (1) together with the bolt component (9).

The invention concerns a supplementary actuation device in accordance with the preamble of claim 1. The invention furthermore concerns a housing in accordance with the preamble of claim 11 and a twist lock device in accordance with the preamble of claim 16.

Twist lock configurations are used in many places in motor vehicles, e.g. for the steering wheel lock, door lock, gas tank lock, etc. Other areas of application are presently being developed with electrically powered motor vehicles, e.g. with electric cars or those having hybrid drives. Locking devices of the present type in motor vehicles of this type serve, in particular, for the locking of the batteries or accumulators necessary for the drive in vehicles, thereby ensuring that they are seated securely in place. With a locking of this type, which is usually accompanied with a turning of a bolt 90° in relation to a housing, it is desirable that a feedback accompany a successful locking in order to ensure that a battery is properly held and locked in place, and is thereby ready for use. This is supplied by means of a switch activated in the course of the locking process.

The twist lock devices of the prior art have disadvantages insofar as the indication of a locking, or the emitting of a corresponding signal does not occur reliably on a regular basis because the bolt for the twist lock device, which extends into a housing for the object to be locked in place, at times entering imprecisely, and this along all of the three axes (X, Y, Z). In turning the bolt in relation to the housing for the purpose of locking said object in place, which should result in the switch being activated, it may occur that the switch is not activated because the bolt is skewed or displaced along the Z axis (vertically) when inserted. In some cases it may occur that the bolt is turned the prescribed 90°, but due to the skewing and displacement along the Z axis, does not activate the switch. In this case, an error is detected that does not actually exist, or an existing error is not detected.

In order to minimize problems of this type, it is known in the prior art to provide a housing having a plate that can be shifted along the X and Y axes, that can compensate for tolerances along the X and Y axes (e.g. horizontally). For this, there is a switch located on the plate which is intended to detect the completed locking. This configuration has, however, disadvantages insofar as the individual components are complex and expensive. Furthermore, the switch is attached to the moveable plate such that the associated wiring harness must also be configured to be moveable, or respectively, adjustable, e.g. as described in DE 10 2006 01 72 48 B4. The lock housing as a result, can only be sealed effectively by complex measures and expensive, extensive handling.

Based on this, the invention assumes the basic objective of overcoming the problems specified above, and to provide a configuration for a twist lock, by means of which, despite the large tolerances occurring, or respectively, the imprecision, a locking is reliably detected.

This objective is attained according to the invention with regard to the supplementary actuation device by the characteristics of Claim 1, with regard to the housing by Claim 11, and with regard to the twist lock device by Claim 16.

For this, the device is capable of, from the four degrees of freedom of movement (linear motion along the X, Y and Z axes, and rotation about the Z axis) filtering out only the rotation about the Z axis, and detecting its precise angular position. The motion along the remaining three axes is deselected thereby, and ignored.

A supplementary actuation device is proposed for a twist lock device in a motor vehicle, having a base component with a holding device disposed thereon, wherein the holding device with a holding fixture is designed to hold the position of a corresponding bolt component that is to be held in relation to areas opposite of said bolt component. For the position of the bolt component, the holding fixture has at least one pressure component. Furthermore, the supplementary actuation device contains at least one contact surface for the rotational support of the supplementary actuation device in a guide, as well as an actuation component for actuating a corresponding actuation device, or respectively, an actuation device that acts in concert with said actuation component when locked in place.

In one embodiment according to the invention, the pressure component has at least one spring tensioned component, in particular a resilient spring component, or a slider component.

In another embodiment according to the invention, the holding device is designed as an integral part of the base component.

According to yet another embodiment according to the invention, the contact surface is designed onto the base component, in particular at an edge region of the base component. The contact surface can be designed as a sliding surface.

In one embodiment, the supplementary actuation device has an actuation device, which is designed to actuate a switch. The actuation device is disposed, for example, at an edge region of the supplementary actuation device and/or at an edge region of the base component. It may be designed as a node and/or as a projection. In one embodiment the actuation component extends, in the direction of the outer periphery, from the supplementary actuation device, in particular, from the base component.

In one embodiment according to the invention, the holding fixture has a substantially V or U shaped cross-section.

Furthermore, a housing is proposed for a twist lock device for a motor vehicle containing a housing base having an opening for a bolt component, as well as at least one wall component disposed at least partially around the opening, extending from the housing base. For this, a guide is formed on the at least one wall component for rotational guidance or, respectively, support, of the at least one contact surface of a supplementary actuation device according to the invention.

In one embodiment, the guide has a supporting surface for the at least one contact surface. The guide and/or supporting surface can be formed on one of the faces of the at least one wall components facing away from the housing base. In one embodiment, the guide and/or supporting surface are designed as being at least partially circular in shape.

In yet another embodiment of the invention, the housing has a holding fixture for the alignment of an actuation device, which functions in concert with the actuation component of the supplementary actuation device.

In accordance with the invention, a twist lock device for locking a battery of a motor vehicle in place, in particular a motor vehicle with an electric drive, is proposed, wherein a rotationally moveable supplementary actuation device according to the invention is introduced in the guide of a housing according to the invention.

In one embodiment, the actuation component acts together with the actuation device in a rotational manner. The actuation component can be disposed in such a manner that in locking the twist lock device, the actuation device is actuated by means of the actuation component. For this, the actuation device can generate an electronic signal in one embodiment.

It is furthermore proposed that the twist lock device according to the invention be used for locking a battery configuration in place in a motor vehicle, in particular in a motor vehicle driven by electricity.

Further characteristics and advantages of the invention can be derived from the following description of embodiment examples of the invention, based on the figures in the drawings that depict details substantial to the invention, and from the Claims. The individual characteristics may be realized individually or in numerous arbitrary combinations in a variation of the invention.

Preferred embodiments of the invention shall be explained in the following in greater detail based on the attached drawings. They show:

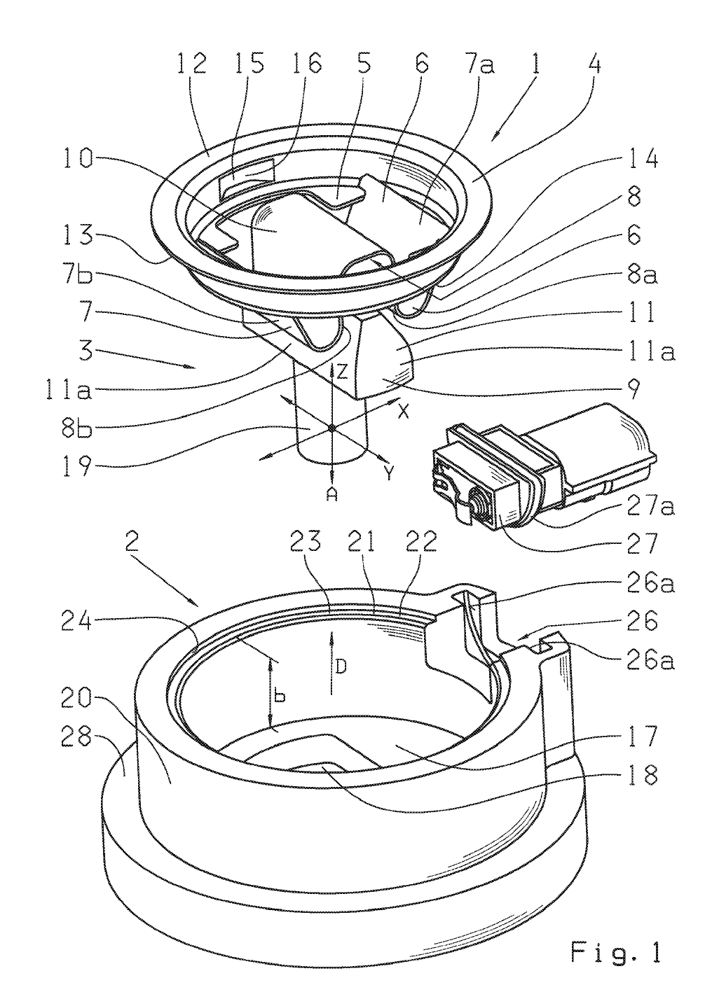

FIG. 1 By way of example, a supplementary actuation device, a housing, an actuation device, and a bolt component for use in a twist lock device according to one possible embodiment of the invention;

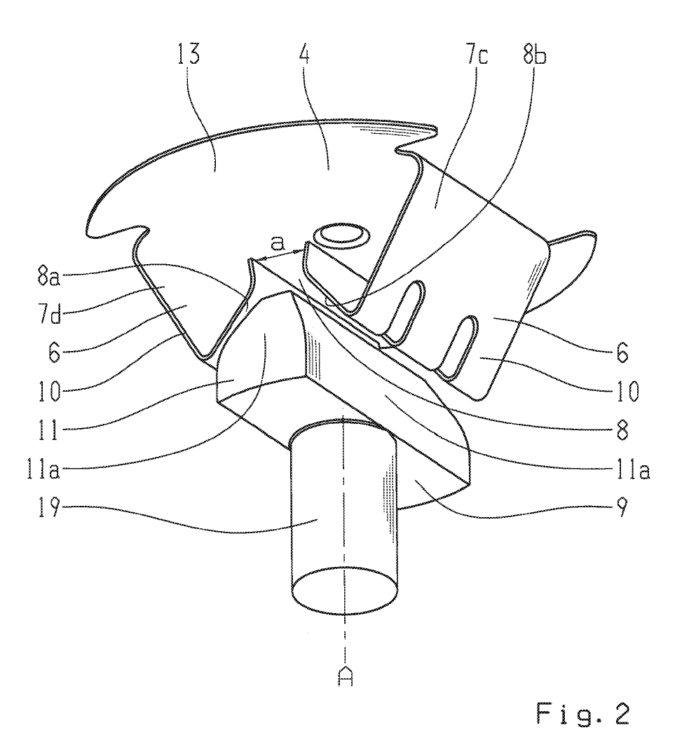

FIG. 2 By way of example, a supplementary actuation device and a bolt component according to another embodiment of the invention;

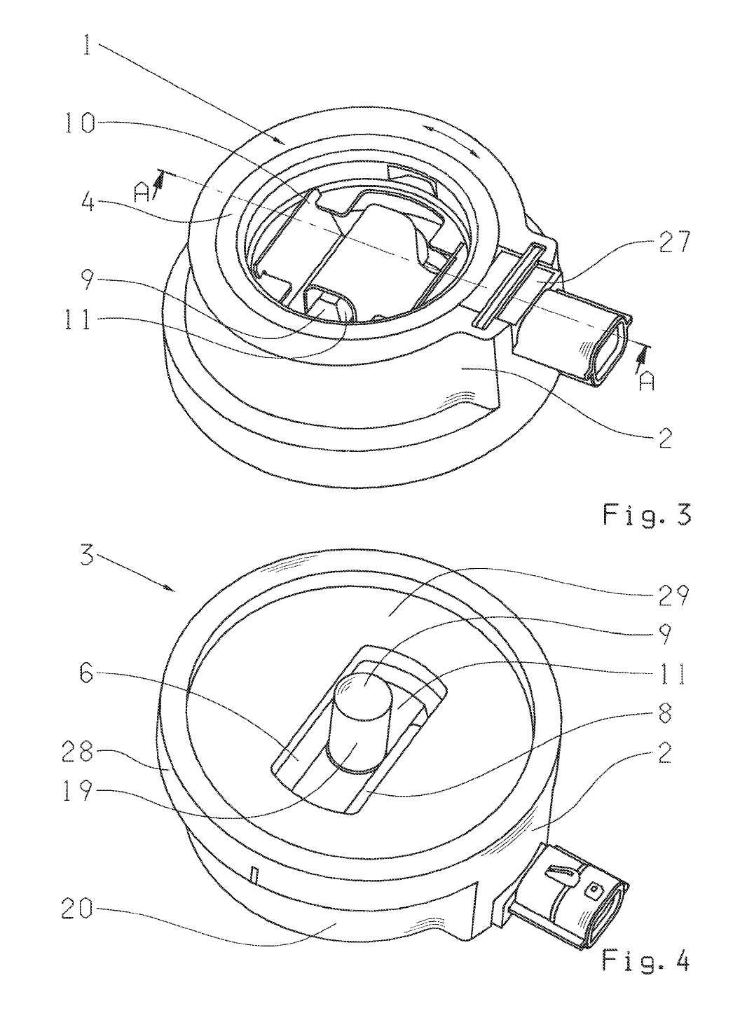

FIG. 3 By way of example, a housing containing therein a supplementary actuation device according to another embodiment of the invention;

FIG. 4 By way of example, a twist lock device from below, having a therein inserted bolt component in accordance with an embodiment of the invention according to FIG. 1;

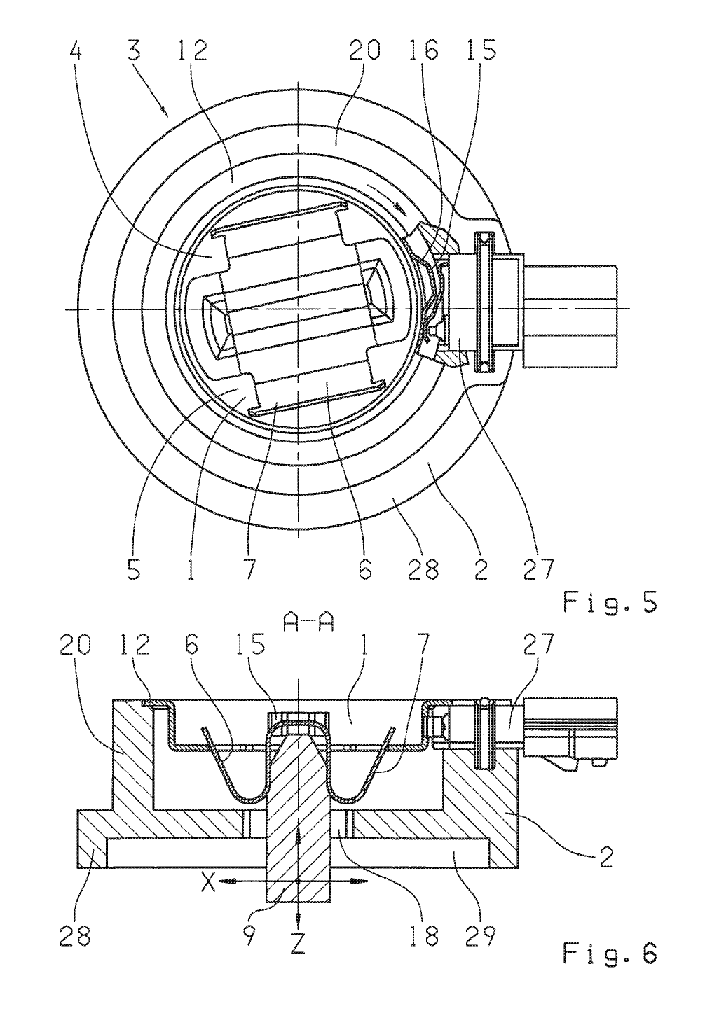

FIG. 5 By way of example, a partially open depiction of a supplementary actuation device inserted in a housing in accordance with the embodiment of the invention according to FIG. 1; and

FIG. 6 A sectional view of the twist lock device with an inserted bolt component cut along the line A-A in accordance with the embodiment of the invention according to FIG. 3.

In the following description and the drawings, identical reference symbols refer to components having the same or similar functions.

FIG. 1 shows a supplementary actuation device 1 according to the invention and a housing 2 according to the invention, in which the supplementary actuation device 1 as well as the housing 2 are used, for example, to form a twist lock configuration or twist lock device 3 according to the invention. The supplementary actuation device 1 serves to reliably deliver a signal in the case of a successful locking, and represents in this manner a supplementary device for the actuation of, for example, a switch.

The supplementary device for actuating, or respectively, the supplementary actuation device 1 in the embodiment of FIG. 1 consists of a plate-like base component 4 with a partially open base 5. At least one pressure component 6, e.g. a spring component 7 in the shape, for example, of a W-shaped bent spring is disposed in the opening of the base 5 such that the exterior legs 7a, 7b of the W-shaped bent spring component 7 rest against an edge of the open base 5 of the base component 4. The spring component 7 is spring tensioned in this manner against the open base 5, e.g. by means of clamping it against said open base 5. In order to ensure that the legs 7a, 7b do not slip in relation to the base component 4, this can be held in place, for example, in a suitable manner, e.g. by means of clamping, or designed as an integral part, or otherwise by means of shape, force or firmly bonded types of connection.

An inner region or central region, respectively, of the W-shaped bent spring component 7 or the pressure component 6 is designed in the shape of a holding fixture 8 for a bolt component 9 such that the pressure component 6 can engage or make contact with two opposing regions of the bolt component 9 such that a clamping of the bolt component 9 is possible. The holding fixture 8 has, for example, a V- or U-shaped cross-section by means of which ramp surfaces 8a, 8b are made available as a guide for an insertion or penetration of the bolt component 9. The spring component 7 supported on the open base (edge) forms thereby a holding device 10 for a corresponding bolt component 9 in which said bolt component 9 can at least be partially inserted, e.g. with a head 11 corresponding thereto. In order to best catch on the inserted bolt component 9, the holding fixture 8 preferably has a cross-section shaped to conform to the bolt component 9 that is to be held or received. If the bolt component 9 enters the holding fixture 8 at an angle, or twisted, the pressure component, due to its being spring tensioned, can exert pressure against the bolt component 9, e.g. against diametrically opposing ends or along the length of said bolt component 9. If the bolt component 9 enters in a manner that is not intended, or not with the intended longitudinal orientation, a turning of said bolt component 9 can cause in turn a turning of the holding fixture 8 and thereby the supplementary actuation device 1 connected to said holding fixture 8.

The supplementary actuation device 1 has an edge region 12, for example, e.g. an edge region 12 in the shape of a plate edge, inside of which a contact or supporting surface 13 is formed. The contact surface 13 is formed, for example, on the base component 4 at an edge region 12 of the base component 4. The contact surface 13 is formed for example, on one of the surfaces of the edge region 12 facing the base 5. The contact surface 13 serves to support or make contact with a housing 2 according to the invention, in particular on one of said supporting surfaces. The contact surface 13 is preferably in the shape of a closed ring, but can also be segmented, having wing components, for example, or designed in some other manner. The contact surface 13 is designed to ensure that rotation is possible on the supporting surface, in particular in an, at least in part, ring shaped guide, e.g. a ring shaped guide corresponding to a housing 2 according to the invention. The contact surface 13 is designed as a sliding surface in order to exhibit the least resistance possible to a rotation of the supplementary actuation device, by means, for example, of a Teflon coating, or in the form of a polished or smooth surface, etc. A holding device 10 is disposed within the circumference of the contact surface 13 for example, which extends, for example, beyond the lower end 14 of the contact surface 13 or the base component 4, respectively.

The supplementary actuation device 1 has an actuating component 15, e.g. in the shape of an outer circumference (FIG. 1: X, Y axis) of nodes projecting from the base component, for example, or a projection 16, for example. The actuating component 15 is disposed, for example, on an (outer) edge region or peripheral edge of the base component 4. It is also conceivable to dispose the actuating component 15 on a holding device 10, for example. The actuating component 15 functions together with a corresponding actuating device of a housing 2 according to the invention. The actuating device of the housing 2 in this case is, for example, a switch, and sends an electronic signal to a monitoring unit when an actuation by means of the actuating component 15 as a result of a rotation of the supplementary actuation device 1, as a result of a locking in place, has occurred. The actuation component 15 is suited, for example, to exert pressure on a switching component of the actuating device resulting from a locking in position, thereby initiating a switching process (FIG. 5). The actuating component 15 can be designed to be an integral component of the supplementary actuation device 1, e.g. the base component 4, or attached to said supplementary actuation device 1 in some other manner, e.g. glued, or screwed onto said supplementary actuation device 1, etc.

FIG. 2 shows another embodiment of a supplementary actuation device 1 according to the invention, whereby the base component 4 is designed substantially in the shape of a disk. The holding device 10, in this case, has two spring components 7c, 7d designed as pressure components 6, as integral parts of the base component 4, each designed in the shape of a V, for example, which work together when holding a bolt component 9, such that they are apply pressure against a bolt component 9 that is to be held therein, disposed on the base component 4. The legs of the spring components 7c, 7d, the inner surfaces of which are opposite one another, are separated from one another at a distance a, the width of which corresponds to a bolt component 9 that is to be held therein, in particular, it corresponds to a head 11 of the bolt component 9 shaped for the upcoming locking in position. The two spring components 7c, 7d form, in the same manner as the W-shape of the previously explained embodiment, a holding fixture 8, having a tapered cross-section, of the holding device 10, which promotes, or respectively, supports in a guiding manner, the insertion of a bolt component 8, also by means of ramp surfaces 8a, 8b.

With an embodiment that is not shown, the base component 4 has a slider component, for example, which, on both sides of a holding fixture 8 (in the form of a recess or opening, for example) for the bolt component 9 to be held therein, has displaceable, e.g. spring loaded clamp surfaces or components, such that pressure can be applied to a bolt component 9 held between said spring loaded clamp surfaces or components. The slider component can comprise, for example, a slider, designed as a connecting member.

The supplementary actuation device 1 acts together with a housing 2 according to the invention, with which a bolt component 9 is to be locked in position by means of rotating said housing 2 and bolt component 9 in relation to one another. The housing 2 has a housing base 17, within which there is an opening 18 for a bolt component 9, in particular a head 11 of a bolt component 9. A bolt component 9 can, together with the housing base 17, lock the bolt component 9 against removal from the opening 18 by means of rotation, for example, in that a head 11 of the bolt component 9, from which an arm component 19 of the bolt component 9 that extends laterally, i.e. crosswise to the insertion axis D (i.e. T-shaped or inverted L-shaped, for example), is guided through the opening 18, and is rotated in relation to the housing base 17 by the bolt component 9 after the head 11 has been inserted. For this, the opening 18 is, for example, an elongated hole, and the head 11 has a substantially rectangular cross-section. If the rectangular cross-section is rotated about an axis A after passing through the corresponding elongated hole, the bolt component 9 cannot be removed without being rotated again, thereby locking said bolt component 9 in place. The dimensions of the head must be suited in this case such that after rotating the head, it extends over at least an edge of the opening 18, i.e. the width of the opening 18. Preferably the head 11 has beveled regions or surfaces, e.g. ramp surfaces 11a, which support insertion in the holding fixture 8. A front part of the head 11, when seen from the perspective D of the opening, has, for this purpose, the shape of a roof, e.g. a pitched roof or a hipped roof.

The housing 2 has a wall component 20 disposed around the opening or hole 18, substantially in the shape of a circle, for example. The wall component 20 extends from the base 17 of the housing along the axis D of the opening for the bolt component 9, away from or upwards from the opening 17 and is designed in the shape of a ring, for example, e.g. as a hollow cylinder, or in the manner of a tube section. The wall component 20 may be comprised of numerous sections, e.g. in the form of multiple pillars, or as a single unit, or have different cross-sections for example, that have a cross-section tapering, along the insertion axis D, away from the housing base 17.

The wall component 20 has a guide 21, separated, for example, at a distance from the housing base 17, on which a supplementary actuation device 1 can be supported or guided in a rotational manner. A hollow space is formed between the supplementary actuation device 1 and the housing base 17 by the wall component 20, in which a locking bolt component 9 can be held. The distance b is established by means, for example, of the selection of the corresponding height of the wall component 20, in particular such that a bolt component 9 can be inserted to the intended depth in the supplementary actuation device 1 inserted into the guide 21.

The guide 21 of the housing 2 is designed in the shape of a groove 22, for example, e.g. as an annular groove on a face of the wall component 20 (in the insertion axis D), which lies opposite of the housing base 17. The groove 22, having the cross-section for example of a semi-open rectangular groove, forms, for example, a supporting surface 23 for vertical support (Z axis), as well as an edge 24 for horizontal support (X, Y axes) of a supplementary actuation device 1 held in the guide 21. The supporting surface 23 can also be designed as a sliding surface like the contact surface 21, in order to exhibit the least resistance possible to a rotation of the supplementary actuation device, e.g. by coating said supporting surface 23 with Teflon, or having a polished surface, etc.

In order to safeguard the supplementary actuation device 1 against falling out of the guide 21, and to exert a counter pressure on an inserted bolt component 9, the housing 2 can be closed by a cover (not shown) or pushed into position against a closing component such as, for example, a mounting wall, an attachment device, etc. For this, the housing 2 may have, for example, mounting surfaces, with which the housing 2 can be permanently attached in a releasable manner for example. The guide 21 can also be disposed within the longitudinal extension (Z axis) of a wall component 20, i.e. between the housing base 17 and face, such that a falling out through the slot shaped, or rectangular groove shaped guide 21 is prevented.

The housing 2 has an opening or a holding fixture 26 for an actuating device 27, which is, for example, designed into the wall component 20. The holding fixture 26 is, for example, equipped with engagement components 27a corresponding to the actuation device 27 that is to be held therein, by means, for example, of suitable fitted moldings. The actuating device 27 can also be anchored in the holding fixture 26 by other means, e.g. through a press fit, gluing, screws, or other known Kraftform or firmly bonded processes. For the purpose of holding the actuating device 27, the wall component 20 can be reinforced in the region of the holding fixture, in order to create a larger supporting surface and/or to form the engagement component 26a.

The housing base 17 may have an edge region that extends laterally beyond the dimensions of the wall component 20 in order to provide additional supporting surfaces for the objects that are to be locked into place with the bolt component 9, e.g. accumulators or batteries in an electrically powered motor vehicle that are to be locked into position. The housing base 17 can additionally form a fitted region 29 in the form of a cap, for example, which corresponds to the shape of the object to be locked into position, in order to provide support in the vertical and horizontal axes (FIG. 6).

The housing 2 and the supplementary actuation device 1 according to the invention are disposed or used, in a motor vehicle, in particular together with the actuating device 27, to form a locking configuration according to the invention, in particular a twist lock device 3. In particular, batteries in a motor vehicle, for example, are locked in place with the twist lock device 3 according to the invention, wherein the batteries serve to power the electrically powered vehicle, for example. A bolt component 9 is disposed on the batteries, for example, which is to be locked in place with a housing 2 according to the invention, wherein the housing 2 is attached to a component of the vehicle body in a permanent manner. The vehicle body component can thereby also form a housing cover for the housing 2.

To create the twist lock device 3 according to the invention (FIG. 3), an actuating device 27, for example, is disposed in the holding fixture 26 and the supplementary actuation device 1 according to the invention in the housing 2 according to the invention, e.g. inserted in the guide 21 of said housing 2. For this, the contact surface 13 of the supplementary actuation device 1 is placed or inserted in position in the guide 21 of the housing 2, e.g. by placing said supplementary actuation device 1 on the bowed or ring shaped support surface 23. In this manner, rotational motion of the supplementary actuation device 1 in the housing 2 is ensured.

For a locking in place, a bolt component 9 is inserted with its head 11 through the housing base 17 of the housing 2 along the insertion axis D, and rotated in the locking direction (arrow in FIG. 5). Through the insertion, the bolt component 9 enters the holding fixture 8 of the holding device 10 in the supplementary actuation device 1 contained in the housing 2 in accordance with the invention (with it head 11, for example), in such a manner that the at least one pressure component 6 of the holding fixture 8 corresponding to the bolt component 9, is placed in position in relation to the ramp surfaces 8a, 8b on the bolt component 9, in particular on the head 11 of the bolt component 9, for example. The V-shape of the configuration of the spring component 7, or 7c, 7d respectively, of the pressure component 6 can support thereby the guidance of the bolt component 9 in the insertion.

As a result of the insertion of the bolt component 9 in the holding device 10, pressure is applied to the bolt component 9 by the pressure component 6 of the holding fixture 8, in particular by the tension of the respective pressure component 6. A semi-rigid connection is established between the bolt component and the supplementary actuation device thereby, e.g. in the form of a clamp. Through rotation, for the purpose of locking, the bolt component 9 contained in the holding device 10 then rotates the supplementary actuation device 1 in the guide 21. In contrast to the prior art, a switching procedure is initiated by the supplementary actuation device 1, and not by the bolt component 9 subjected to the tolerances of said bolt component 9.

The advantages in accordance with the invention are obtained in particular when the bolt component 9 is inserted in the housing 2 with a greater degree of imprecision. In this case, the tolerances can amount to several millimeters, and comprise deviations in the X and Y axes (horizontal) as well as in the Z axis (vertical). Tolerances of this type are compensated for by means of the rotational bearing of the supplementary actuation device 1.

If the bolt component 9 is inserted in the holding fixture 8 in such a manner that the respective corresponding cross-sections of said bolt component 9 and holding fixture 8 are aligned with one another, then the at least one pressure component 6 can rest against the bolt component 9. As soon as a rotation is applied to the bolt component 9, the supplementary actuation device 1 rotates with said bolt component 9 and reliably activates the actuating device 27 by means of the actuating component 15 when it has attained the locking position (after rotating ca. 90°).

If the bolt component is not inserted far enough into the holding fixture 8 (along the Z axis), a pressure is first applied to the bolt component 9 when it is pushed against the at least one pressure component 6 in the form of a spring component 7, 7c, 7d of the holding fixture 8 as a result of rotation. Further rotation of the bolt component 9 rotates the holding fixture 8 together with the bolt component 9, as a result of which, in turn, a signal is reliably emitted as soon as the actuating component 15 actuates the actuating device 27. A deviation of the bolt component 9 from the target position along the Z axis is thereby compensated for and is irrelevant with respect to the intended reliable actuation of a switch.

If the bolt component 9 is inserted at an angle, or skewed (along the X or Y axes) in the holding fixture 8, then this rotates together with the supplementary actuation device 1 first in its guide 21 to the extent that it is then inserted to the point where a minimal resistance of the resilient spring component of the at least one pressure component 6 has been obtained, which then applies a pressure to the bolt component 9, or respectively, clamps said bolt component 9. A signal is reliably generated in turn, as soon as the supplementary actuation device 1 has actuated the actuating device 27 on the housing 2 with its actuating component 15 as a result of a rotation. The tolerances of the bolt component 9 inserted imprecisely in the housing 2 along the X and Y axes, or imprecisions, respectively, are compensated for thereby.

If the bolt is inserted with horizontal imprecisions, or displacement to the holding fixture 8 (e.g. along the X axis), then the at least one pressure component 6 (in the form of, for example, the spring components 7, or 7c, 7d) yields accordingly. A reliable generation of a signal is also obtained in this case. The same applies to imprecision or displacement along the Y axis, wherein the pressure applied to the bolt component 9 by the pressure component 6 enables a basically non-rotatable connection with a bolt component 9 that is only partially inserted or held.

### REFERENCE SYMBOLS

1 Supplementary actuation device
2 Housing
3 Twist lock device
4 Base component
5 Base
6 Pressure component
7 Spring component
7a, 7b Legs
7c, 7d Spring components
8 Holding fixture
8a, 8b Ramp surface holding fixtures
9 Bolt component
10 Holding device
11 Head
11a Ramp surface head
12 Edge region
13 Contact surface
14 Lower end
15 Actuating component
16 Projection
17 Housing base
18 Opening
19 Arm component
20 Wall component
21 Guide
22 Groove
23 Supporting surface
24 Edge
26 Holding fixture
26a Engagement component
27 Actuating device
27a Engagement component
28 Edge region
29 Fitted region
A Axis
D Insertion axis
X, Y, Z Axes
a Spacing of spring component
b Spacing of housing base—guide

1. A supplementary actuation device for a twist lock device in a motor vehicle, characterized by a base component having a holding device disposed thereon, wherein the holding device includes a holding fixture for the positioning of a bolt component that is to be held therein in corresponding regions opposite of said holding fixture, wherein the holding fixture has at least one pressure component; wherein the supplementary actuation device also includes at least one contact surface for rotational support of the supplementary actuation device in a guide; and wherein the supplementary actuation device includes at least one actuating component for actuating an actuating device acting in concert with said when a locking into position is executed.

2. The supplementary actuation device of claim 1 characterized in that the at least one pressure component has a spring tensioned component.

3. The supplementary actuation device of claim 1 characterized in that the at least one pressure component has a slider component and/or a resilient spring component.

4. The supplementary actuation device of claim 1 characterized in that the holding device is designed as an integral component of the base component.

5. The supplementary actuation device of claim 1 characterized in that the contact surface is formed on the base component, in particular at an edge region of the base component.

6. The supplementary actuation device of claim 1 characterized in that the actuation component is designed for actuating a switch.

7. The supplementary actuation device of claim 1 characterized in that the actuation component extends from the supplementary actuation device in the peripheral plane, in particular, away from the base component.

8. The supplementary actuation device of claim 1 characterized in that the at least one actuating component is designed as a node and/or projection.

9. The supplementary actuation device of claim 1 characterized in that the contact surface is designed as a sliding surface.

10. The supplementary actuation device of claim 1 characterized in that the holding fixture has a substantially W-shaped cross-section.

11. The supplementary actuation device of claim 1 further comprising a housing for a twist lock device for a motor vehicle, containing a housing base with an opening for a bolt component, and at least one wall component extending from the housing base disposed at least in part around the opening, characterized in that a guide is formed on the at least one wall component for rotational guidance of at least one contact surface of the supplementary actuation device.

12. The supplementary actuation device of claim 11, characterized in that the guide has a supporting surface for the at least one contact surface.

13. The supplementary actuation device of claim 12, characterized in that the guide and the supporting surface is formed on one of the faces of the at least one wall component facing away from the housing base.

14. The supplementary actuation device of claim 13, characterized in that the guide and/or the supporting surface is designed at least in part in the shape of a circle.

15. The supplementary actuation device of claim 14, characterized in that the housing has a holding fixture for the positioning of an actuating device, which acts in concert with the at least one actuating component of the supplementary actuation device.

16. The supplementary actuation device of claim 15 further comprising a twist lock device for locking a battery in position in a motor vehicle, in particular a motor vehicle with an electric drive, characterized in that the supplementary actuation device is inserted into the guide of the housing in a such manner that it can rotate.

17. The supplementary actuation device of claim 16 characterized in that the at least one actuating component acts in concert with the actuating device in a rotational manner.

18. The supplementary actuation device of claim 16 characterized in that the at least one actuation component is disposed such that when the twist lock device is locked in position, the actuating device is actuated by means of the at least one actuating component.

19. The supplementary actuation device of claim 16 characterized in that the actuating device generates an electronic signal when actuated.

20. The supplementary actuation device of claim 16 wherein the twist lock device is configured to lock a battery configuration in a motor vehicle, in particular in an electric powered motor vehicle.
